(19) United States
(12) Patent Application Publication
(10) Pub. No.: US 2004/0114945 A1
(43) Pub. Date: Jun. 17, 2004

(54) Printing method of printer apparatus

(76) Inventor: Tatsuya Takagi, Tokyo (JP)

Correspondence Address: RABIN & Berdo, PC, 1101 14TH STREET, NW, SUITE 500, WASHINGTON, DC, 20005, US

(21) Appl. No.: 10/637,647

(22) Filed: Aug. 11, 2003

(30) Foreign Application Priority Data
Aug. 16, 2002 (JP) JP2002-237505

(51) Int. Cl. G03G 15/00

(52) U.S. Cl. 399/21

(57) ABSTRACT

At the detection of occurrence of sheet feeder jam, in the occasion when medium in the course of one face printing exist, the one face printing is continued. And, this medium is inserted in the duplex printing unit. After this, in a process of demanding relief of sheet feeder jam A\mathring{2}, a relief of sheet feeder jam is demanded. And, in a process of watching the duplex print unit A\mathring{4}, change in the duplex printing unit is watched. In the occasion when there is no change in the duplex print unit, after printing process is re-started, re-use of the medium is allowed.

### BACKGROUND OF THE INVENTION

1. Field of the Invention

The present invention relates to a printing method of printer apparatus.

2. Description of the Related Art

In the conventional printer apparatus, in the occasion when a sheet feeder jam occurred, either of the next two methods were adopted. (1) The printer apparatus is stopped at once. And, the occurrence of sheet feeder jam is presented at an operator's panel etc. Then, relief of jam is demanded to the operator. After the operator relieved the sheet feeder jam, the printing process was re-started. In this occasion, the medium in the course of printing was abandoned.

(2) Although, in principle, it is same as (1); in the occasion when there is a sheet already printed with one of its faces at the moment of occurrence of sheet feeder jam, the printing process is continued with the other face. After this medium was issued, the printing process was stopped. And, the occurrence of sheet feeder jam was presented at an operator's panel etc, so as to demand relief of jam. After operator relieved the jam, printing process was re-started. Here, the sheet feeder jam means a state that sheet feeding sensor does not become ON, despite passing of a certain time interval from the start of sheet feeding operation.

However, there was a following problem remained unsolved in the conventional art mentioned above. That is, at the moment of occurrence of sheet feeder jam, there is an occasion when a sheet exists waiting in the duplex printing unit printed completely with one of its faces. In this occasion, printing process was stopped as well. Then, the operator must exclude the sheet waiting in the duplex printing unit as well as the operator must relive the sheet feeder jam. Otherwise, the printing process could not be re-started.

As a result, when printing process was re-started, it must be done about the part which is same as the part already completed printing with one face. Further, when a sheet feeder jam occurred, even if the printer was in the state that sheet feeding from other sheet feeder or duplex printing unit is possible: the printing process was stopped at once as well.

### SUMMARY OF THE INVENTION

The present invention adopts next configurations in order to solve the problems mentioned above.

<Configuration 1>

A printing method of printer apparatus having mechanism for reversing media, so as to perform duplex printing; wherein, at the detection of occurrence of a sheet feeder jam, in the occasion when at least one medium in the course of one face printing exists, the one face printing with this medium is continued, and this medium is conveyed in said mechanism for reversing medium, after the one face printing completed; then relief of sheet feeder jam is demanded, and printing process is re-started after jam is relieved.

<Configuration 2>

A printing method of printer apparatus according to Configuration 1; wherein, at the re-starting of said printing process, either said medium printed with one face or a new medium fed from the sheet feeder cassette of said printer apparatus, is selected.

<Configuration 3>

A printing method of printer apparatus having a duplex printing unit for reversing media, and demanding relief of said sheet feeder jam at the occurrence of said sheet feeder jam; wherein at the detection of occurrence of said sheet feeder jam, in the occasion when medium printed with one face exist in said duplex printing unit, printing process to the other face of medium is performed, and after the printing process is completed, a relief of sheet feeder jam is demanded.

<Configuration 4>

A printing method of printer apparatus demanding relief of said sheet feeder jam at the occurrence of said sheet feeder jam; wherein conveying route for media in said printer apparatus is watched; a sheet feeder cassette able to be changed with the sheet feeder cassette causing said sheet feeder jam, is selected, and printing process is continued with media fed from the changed sheet feeder cassette; after all the media fed from every available sheet feeder cassette is exhausted, a relief of jam is demanded.

<Operation>

In the occasion when printing media exist, after relief of jam; even if they are printed with one of their faces, it can be re-used as far as normal process is performed with these printing media as well as it should be performed when the printer apparatus normally operates and the normal printing state is kept. Therefore, in present invention, watching in the duplex printing unit is continued. Not to mention the occasion when printing with one face is completed at the time of occurrence of sheet feed jam, even if the media are in the course of one face printing, it is continued. A relief of jam is demanded, after the media are inserted in the duplex printing unit. And, a normal process performed when the printer apparatus is normally operating, is kept. The media kept in a normal printing state at re-starting of printing process, is re-used. Thus, needless printing process at re-starting of printing can be avoided.

### BRIEF DESCRIPTION OF THE DRAWINGS

FIG. 1 is a flow-chart showing the process of printing method of Embodiment 1.

FIG. 2 is a sectional view showing the structure of printing apparatus.

FIG. 3 shows a state of conveying sheets relating to Embodiment 1.

FIG. 4 is a flow-chart showing the process of printing method of Embodiment 2.

FIG. 5 shows a state of conveying sheets relating to Embodiment 2.

FIG. 6 is a flow-chart showing the process of printing method of Embodiment 3.

FIG. 7 shows a state of conveying sheets relating to Embodiment 3.

FIG. 8 shows the printing order of Embodiment 1.

FIG. 9 shows the printing order of Embodiment 2.

### DETAILED DESCRIPTION OF THE PREFERRED EMBODIMENTS

Hereafter, the preferred Embodiments of present invention will be described referring to the drawings.

<Embodiment 1>

Embodiment 1 relates to a printing method of enabling re-use of media for printing, that is, printing sheet either of which surface is completely printed, when jam in the printer occurred. Such printing media are entirelv same as the printing medium, which is printed in the occasion when jam in the printer had not occurred between occurrence of jam and relief of jam. To achieve this re-use, the duplex printing unit in the printer is watched continuously, in order to detect occurrence of jam and existence of printing media at that time.

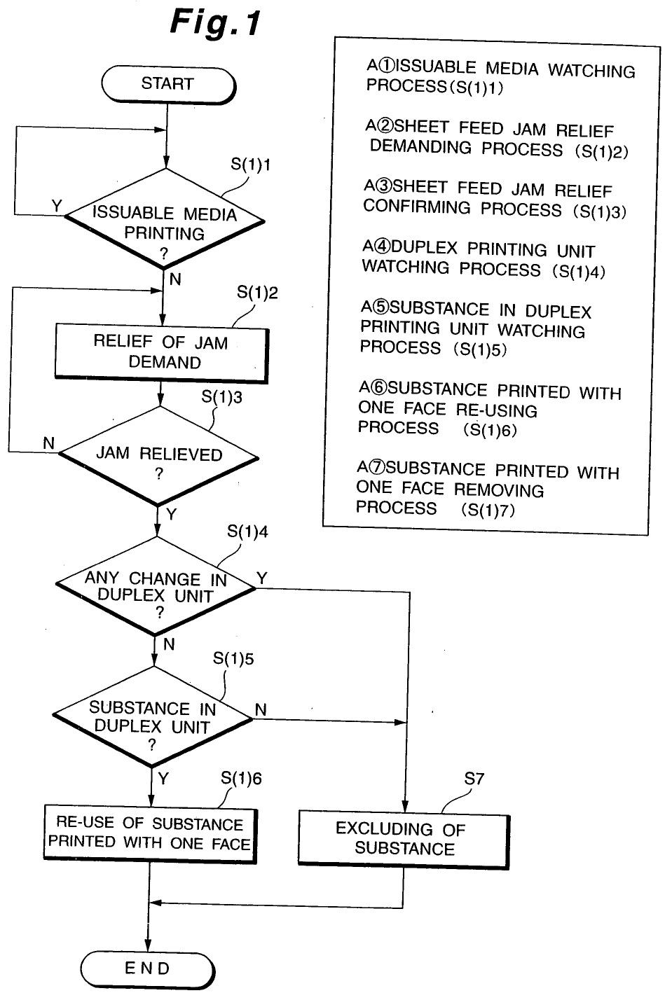

FIG. 1 shows the processes of this method with a form of flow-chart as Embodiment 1.

In FIG. 1, the printing method for printer apparatus according to Embodiment 1 comprises A\mathring{1} process of watching existence of issuable media A\mathring{2} process of demanding relief of jam in sheet feeder, A\mathring{3} process of confirming relief of jam in sheet feeder, A\mathring{4} process of watching abnormalities in duplex printing unit, A\mathring{5} process of watching media existing in duplex printing unit, A\mathring{6} process of re-using double-faced media completely printed on one of its faces, and A\mathring{7} process of removing media in apparatus.

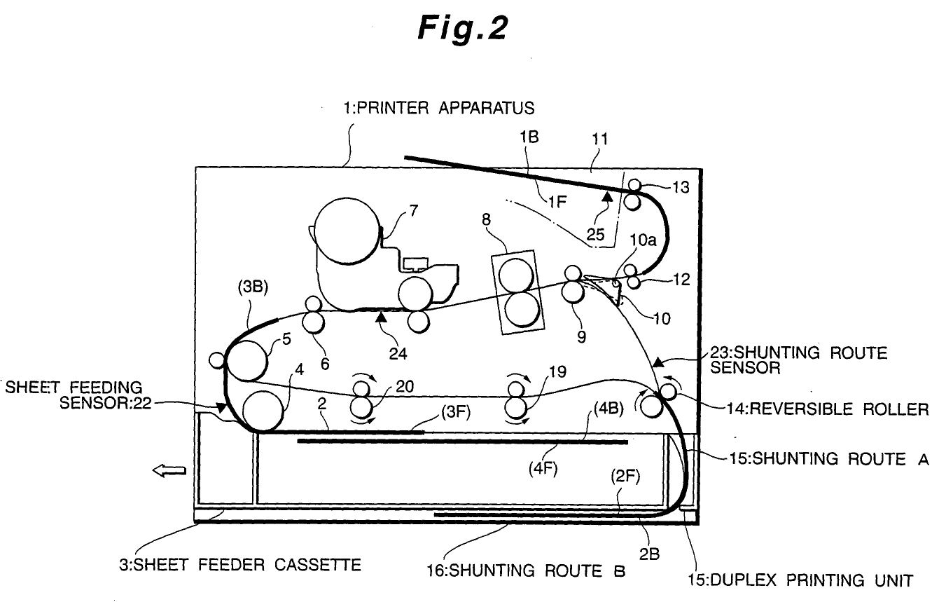

As an introduction to the description of these processes, an example of a printer apparatus, which the method of present invention applied to, is described referring to FIG. 2 about its schematic structure and easy operation.

FIG. 2 shows a structure of printer apparatus.

In FIG. 2, a sheet feeder cassette (tray) 3, which is detachable and contains paper (printing medium) 2, is provided to a printer apparatus 1. This sheet feeder cassette 3 is able to come to the direction indicated by an arrow. And, a sending roller 4, which is able to rotate to send out paper 2, is provided at an upper portion of sending device, which faces the opening of the sheet feeder cassette 3. Further, a pair of conveying roller 5, which is able to rotate to convey paper 2, is provided upward of the sending roller 4.

Moreover, a pair of conveying roller 6 is provided at the place down in the stream of conveying paper 2 from the conveying roller 5. And, an image forming section 7 is provided at the place down from it. The image forming section 7 is a device for transferring toner image onto the paper 2 according to a memorized data. And, a fixer 8 is provided at the place down from the image forming section 7. Further, a pair of conveying roller 9 is provided at the place down from the fixer 8. And, an interchanging blade 10 is provided at the place down from it.

The interchanging blade 10 is a section for interchanging the direction of conveying the paper 2. For this purpose, it is able to rotate around an axis 10a. And, it declines to choose between the route to an outlet portion 11 and the route for inverting the paper 2. On the route to the outlet, conveying rollers 12, 13 are provide between the interchanging blade 10 and the outlet portion (stacker)11. And, a pair of reversible rollers 14 is provided at the place downward of the interchanging blade 10 as shown in the drawing. Behind the sheet feeding cassette 3, downward of the pair of reversible rollers 14, a shunting route A15 is formed. And, beneath the sheet feeding cassette 3, a shunting route B16 is formed.

These shunting routes A15 and B16 are combined to comprise a duplex printing unit 15. This is a section for inserting the paper 2 to invert it. On the left side of the reversible rollers 14 as shown in the drawing; a pair of conveying rollers 19 and another pair of conveying rollers 20, which rotate respectively to convey paper inverted by duplex printing unit 15, are provided. And, in this structure of printer apparatus; a sheet feeding sensor 22 in the vicinity of sheet feeding roller 4, a shunting route sensor 23 in the vicinity of inlet of duplex printing unit 15, a recording sensor 24 in the vicinity of image forming section 7, and an outlet sensor 25 in the vicinity of entrance of the outlet portion 11 are provided respectively.

As described above, the printer apparatus I shown in FIG. 2 has an internal structure for conveying paper 2, in order to perform duplex printing. And, next, how the paper 2 is conveyed in the printer apparatus 1 will be described. Here, as an example, the process of duplex printing of a series of four papers (1, 2, 3, 4), each of which has front face (designated F) and back face (designated B), is described. In usual occasion, these are printed in the order of IB, 2B, IF, 3B, 2F, 4B, 3F, 4F

As an example, the situation in printer at the moment when the first paper completed the duplex printing is issued at the outlet portion (stacker) 11, is shown in FIG. 2. There, the other three papers are positioned at each of places on the conveying route in the printer apparatus 1 shown with the thick lines. Here, the naked letters such as 1B, 1F etc. express the state of completion of each printing. On the other hand, the letters put in p parentheses such as (3B), (3F) etc. express the state of uncompleted printing.

That is, the state shown in FIG. 2 is the state of completing about 1B, 2B, 1F in the order of printing. So, at this stage, the first paper with 1F, 1B completed duplex printing has already been issued at the outlet portion 11 as mentioned above. And, at the same stage, the second paper (2F), 2B completed printing only about its back face, is inserted in the duplex printing unit 15. Further, at the same stage, the third paper (3F), (3B), which is going to be printed at the next stage, is coming up to the image forming section 7. But, the fourth paper is in the sheet feeding cassette 3 yet. As described above, the schematic structure and brief operation of printer apparatus applied with the present invention, have been introduced. So, the processes comprising the present invention will be described, going back to FIG. 1.

A\mathring{1} Process of Watching Existence of Issuable Media

At the moment, when a sheet feeding jam has occurred, this process is performed to watch the continued printing process until a face of the paper in the course of printing is completed, in the occasion when a paper in the course of printing exists in the printer apparatus 1(FIG. 2). Hereafter, a paper in the course of printing is called an issuable medium. Incidentally, sheet feeding jam is a state that the sheet feeding sensor does not become ON when a certain prescribed time has passed after a paper is fed from the sheet feeding cassette 3. This process corresponds to the step S(1)1 of flow-chart in FIG. 2. This watching process is continued while an issuable medium exists in the printer apparatus I until the printing process with the issuable medium is completed. When completion of the printing process with issuable medium is detected by this step, the control proceeds to the next step. On the other hand, in the occasion when no issuable medium exists in the printer apparatus at the moment when a paper jam occurred, the control starts directly from the next step S(1)2. However, this control of the occasion is not shown in the drawing. In either occasion, no new medium is provided, because a medium jam occurred. The state of this occasion will be described referring to the other drawings.

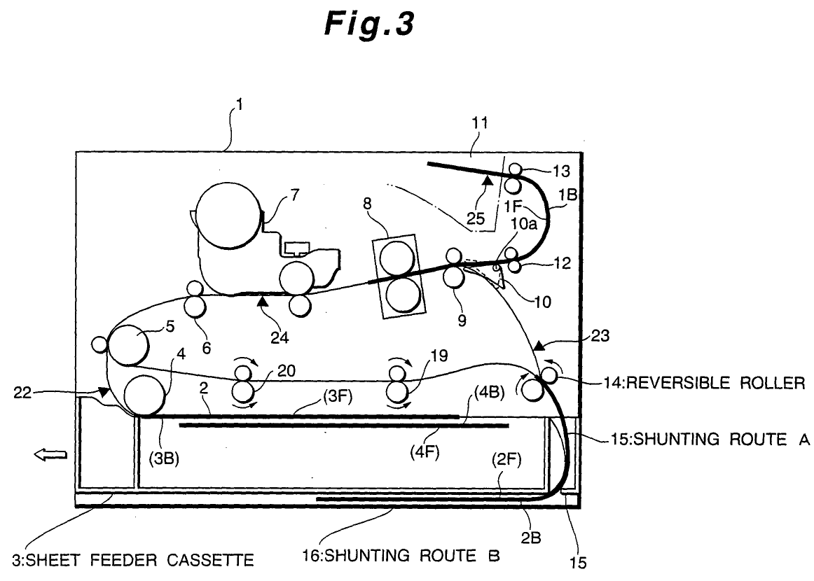

FIG. 3 shows the state of conveying papers according to Embodiment 1.

In FIG. 3, the first paper IF, IB is already printed on both faces of it, though its end is still processed fixing by fixer 8. And, it is not issued yet. However, it is coming out through the outlet opening. On the other hand, the third paper (3F) (3B), which is not printed neither of two faces, is in a state of jamming of sheet. Moreover, the second paper (2F), 2B is completely inserted or almost completely inserted in the duplex printing unit 15.

A\mathring{2} Process of Demanding Relief of Jam in Sheet Feeder

This is a process performed when the operator is ordered to relieve jam in sheet feeder, by presenting the occurrence of sheet feeding jam at an operator's panel etc. This process corresponds to the step S(1)2 in flow-chart.

The relief of sheet feeding jam is ordered to operator, after the issuable medium is completely issued at the outlet portion 11 and/or another issuable medium is completely inserted in the duplex printing unit 15. So, in the state shown in FIG. 3, the relief is not yet demanded to operator. The demand of relieving jam is presented at an operator panel, after the first paper 1F, 1IB (printing completed with both faces) is completely issued and the second paper (2F), 2B is completely inserted in the duplex printing unit 15. The latter is achieved in FIG. 3. The former will soon be achieved in FIG. 3. This is detected by the outlet sensor 25.

A\mathring{3} Process of Confirming Relief of Jam in Sheet Feeder

This is a process of confirming the recovery of sheet feeding. The operator takes care of the sheet feeder cassette 3 etc. to relieve sheet feeding jam. This corresponds to the step S(1)3 in flow-chart. This process is continued until sheet feeding is detected by the feeding sensor 22. And, if it is detected, then, the control proceeds to the next step.

A\mathring{4} Process of Watching in Duplex Printing Unit

This is a process of watching the removement of sheet feeder cassette 3. This corresponds to the step S(1)4 in flow-chart. And, this watching is performed by the shunting route sensor 23 etc. The reason why this watching is performed; is that the printer apparatus cannot maintain the normal state for proceeding to the printing with another face of paper, in case that the sheet feeder cassette 3 is removed by operator after sheet feeding jam occurred until it is relieved. For example, in the case that the front end of second paper (2F), 2B is coming off from the reversible roller 14, the second paper is not able to go for printing with another face. So, the sheet feeder cassette must stay in the printer apparatus 1, in order to keep the issuable paper pinched by the reversible roller 14. This is the same state as the state that sheet feeding jam did not occur. If the removement of sheet feeder cassette or other change in the apparatus occurred, then the control proceeds to the step S(1)7 in flow-chart. Otherwise, the control proceeds to the step S(1)5 in flow-chart.

A\mathring{5} Process of Watching Media Existing in Duplex Printing Unit

This is a process performed to watch whether a paper printed with one of its faces exists in the duplex printing unit 15. This process corresponds to the step S(1)5 in flow-chart. And, this process is performed with the shunting route sensor 23. If there is a paper printed with one of its faces in the duplex printing unit 15, then the control proceeds to the step S(1)6. Otherwise, it proceeds to the step S(1)7. As for the example shown in FIG. 3, there is the second paper (2F), 2B in the duplex printing unit 15. So, the control proceeds to the step S(1)6.

A\mathring{6} Process of Re-Using Double-Faced Medium Completely Printed With One of Its Faces.

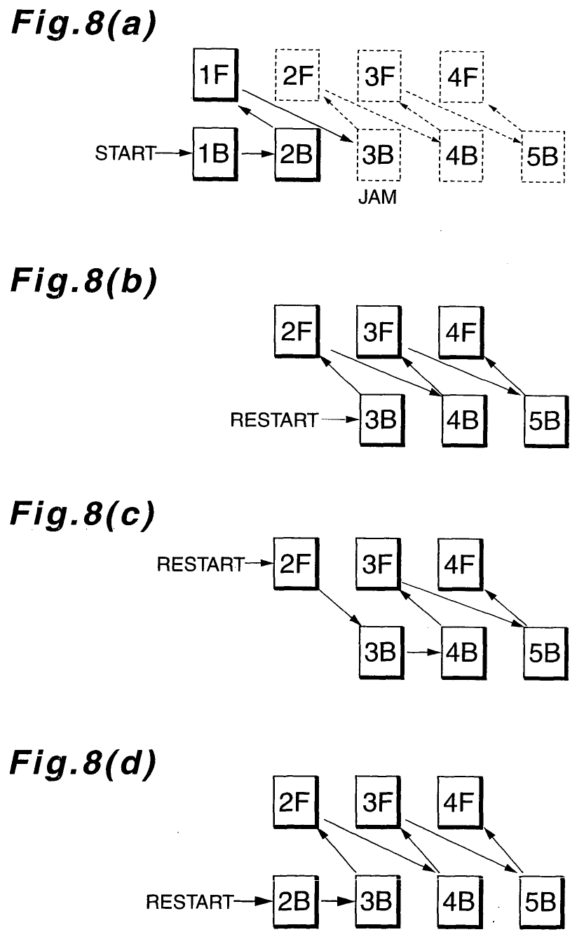

This is a process performed to re-use the second paper (2F), 2B existing in the duplex printing unit 15, because it is judged to be re-usable. This process corresponds to the step S(1)6 in flow-chart. In the occasion of FIG. 3, the printing process in the order of FIG. 8(a) is re-started from the back face of paper 3B as shown in FIG. 8(b). In this occasion, the second paper (2F), 2B; which is judged to be re-usable; is printed next to the third paper (8F),(3B). Then, it is issued at the outlet portion 11. However, in this occasion, it is possible to adopt the other order of printing. That is, as shown in FIG. 8(c), the printing process is re-started from the front face of paper 2F in advance of the third paper (3F),(3B). Then, the third paper (8F),(3B) is printed next to the re-used paper (2f), 2B. That is, the third paper (3F),(3B) in FIG. 8(c) becomes the first paper (1F),(1B) in FIG. 8(a).

A\mathring{7} Process of Removing Media in Apparatus

This is a process performed when the second paper is not re-usable. In this occasion, the second paper is removed by operator. And, the face already printed is printed once more with new second paper, which is newly fed from the sheet feeder cassette 3. This process corresponds to the step S(1)7 in flow-chart. As for the occasion of FIG. 3, the second paper (2F), 2B; which is judged to be un-re-usuable; is removed by operator. And, the printing process is newly re-started from the second paper as shown in FIG. 8(d).

The operation mentioned above, is performed by a control section of the printer apparatus I not shown in the drawings. Incidentally, all these processes are described as a printing method which comprises an independent structure of program. However, the present invention is not limited to this Embodiment. That is, the program of this printing method can be included in the control program of printer apparatus as a part of it. And, this printing method can be performed with the other kind of control as an overall control of the printer apparatus.

<Effect of Embodiment 1>

As mentioned above, the duplex printing unit is watched continuously even if a sheet feeding jam occurred. And, a printing medium completely printed with one of its faces can be detected there. This medium is kept in the state, which is same as the state kept when the sheet feeding jam did not occur. This medium is re-used at re-starting of printing after jam. Therefore, it became possible to avoid issuing of useless printing media in the occasion when a sheet feeding jam occurred.

<Embodiment 2>

Embodiment 2 relates to a printing method in the occasion when the media conveying route from the duplex printing unit 15 is secured at the moment when a sheet feeding jam occurred. And, at the same time, a medium completely printed with one of its faces exists in the duplex printing unit 15. Here, the state that the media conveying route is secured, means the state that obstruction to media passing such as jammed sheet etc. does not exist in the conveying route of media.

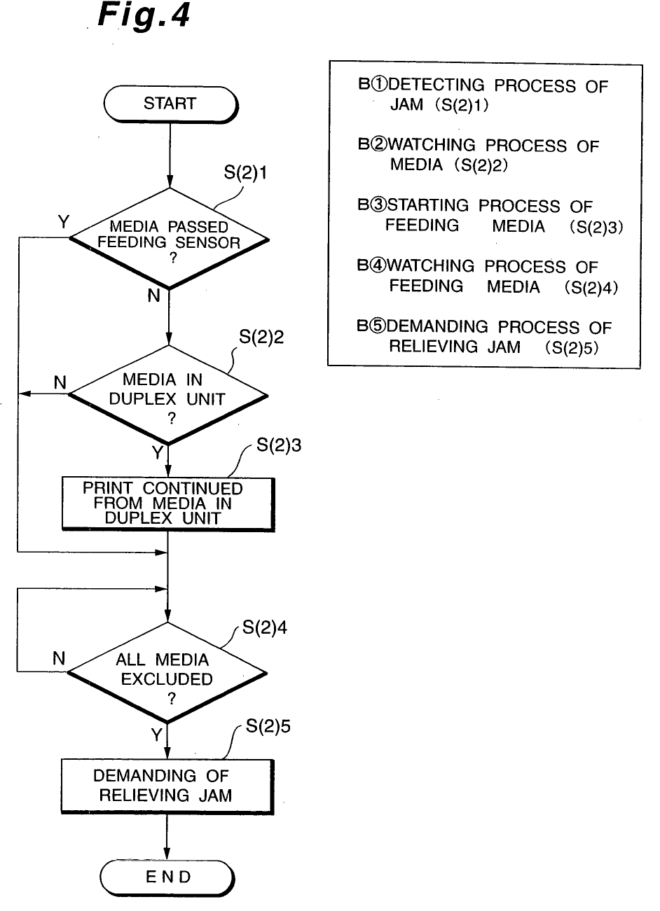

FIG. 4 is a flow-chart showing the printing method of Embodiment 2.

As shown in FIG. 4, the printing method of printer apparatus according to Embodiment 2 comprises B\mathring{1} sheet feeding jam detecting process, B\mathring{2} watching process of medium existing in the duplex printing unit, B\mathring{3} re-starting process of sending medium from the duplex printing unit, B\mathring{4} watching process of sending medium from the duplex printing unit, and B\mathring{5} demanding process of relieving jam in sheet feeder.

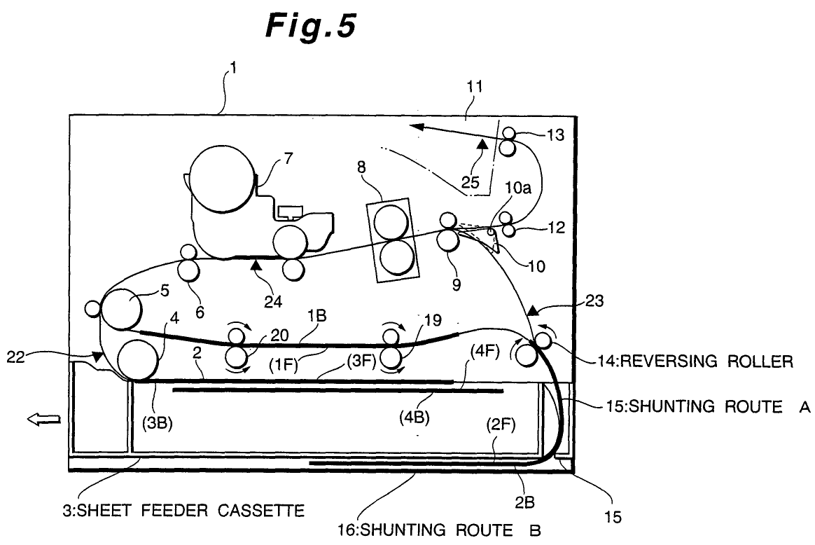

FIG. 5 shows the state of conveying medium concerning to Embodiment 2.

In FIG. 5, the first medium (1F),1B is staying at the place where a pair of conveying rollers 19 and another pair of conveying rollers 20 are provided. And, the second medium (2F), 2B is staying in the duplex printing unit 15. In this state, the third medium is causing a jam of feeding.

B\mathring{1} Detecting Process of Jam in Sheet Feeder

This is a process of continuous watching of sheet feeder to cause j am. The sheet feeding sensor 22 continuously watches the conveying route. A jam in sheet feeder is detected when a certain prescribed time has past before a medium arrives at the sheet feeding sensor 22 after the medium started from the sheet feeder. This process corresponds to the step S(2) 1 in flow-chart.

B\mathring{2} Watching Process of Medium Existing in the Duplex Printing Unit

This is a process performed to watch the duplex printing unit 15 in order to judge whether a medium completely printed with one of its faces exists there or not. This corresponds to the step S(2)2 in flow-chart. This judgement is performed with the shunting route sensor 23. If there is a medium completely printed with one of its,_faces in the duplex printing unit, then the control proceeds to the step S(2)3 in flow-chart. Otherwise, the control jumps to the step S(2)4 in flow-chart. As for the example shown in FIG. 5, it proceeds to the step S(2)3; because the first medium (1F), 1B is staying at the place where pairs of conveying rollers 19, 20 exist, and the second medium (2F), 2B is staying in the duplex printing unit 15.

B\mathring{3} Starting Process of Feeding Media From the Duplex Printing Unit

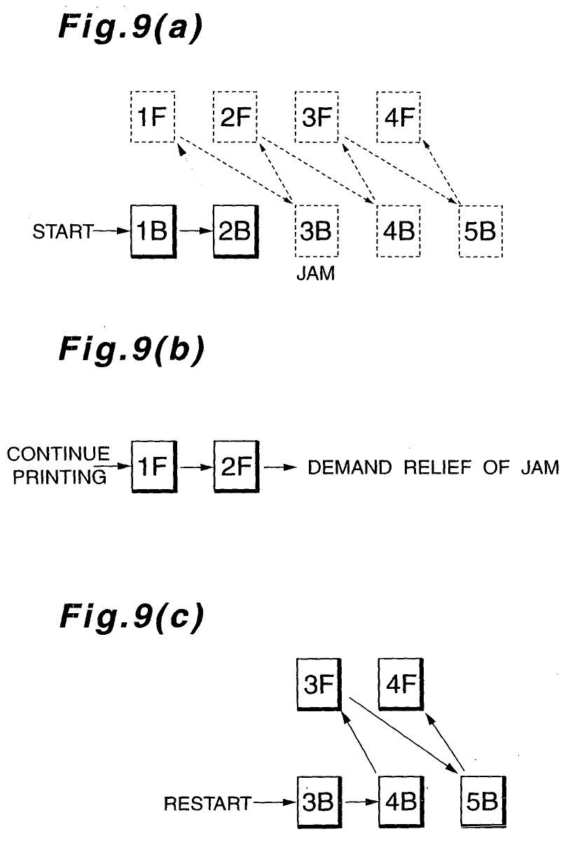

This is a process performed to feed media from the duplex printing unit. This process corresponds to the step S(2)3 in flow-chart. In the occasion of FIG. 5, as shown in FIG. 9(a), the first medium (1F), 1B and the second medium (2F), 2B are completely printed with each one of their faces until a jam occurred. Therefore, as shown in FIG. 9(b), at this step S(2)3, they get continued printing with each opposite (front) faces. The completion of this printing process is confirmed by the recording sensor 24 etc. Then, the control proceeds to the next step S(2)4.

B\mathring{4} Watching Process of Feeding Media From the Duplex Printing Unit

This is a process performed to continue watching media fed from the duplex printing unit until they are all issued. This process corresponds to the step S(2)4 in flow-chart. And, the issuing of all media are confirmed by the outlet sensor 25 together with the recording sensor 24. Then, the control proceeds to the next step S(2)5.

B\mathring{5} Demanding Process of Relieving Jam in Sheet Feeder

This is a process performed to make the operator relieve jam in sheet feeder, by presenting information of the occurrence of jam in sheet feeder at the operator's panel etc. This process corresponds to the step S(2)5 in flow-chart.

This step S(2)5 is processed only after the media completely printed with each one of their faces are printed with the other faces and issued at the outlet portion 11. And, it is not until these media are issued that the fact jam in sheet feeder has occurred is informed to the operator via operator's panel etc. so as to make the operator relieve jam. As for the state shown in FIG. 5, the first medium (1F), 1B and the second medium (2F), 2B are going to complete duplex printings to become media 1F, 1B and 2F, 2B issued at the outlet portion 11. After all, relief of sheet feeder jam is demanded.

And, after the operator relieved jam, the printing process is re-started from the third medium newly fed from sheet feeder cassette 8 in the order shown in FIG. 9(c).

The operation mentioned above is performed by a control section of the printer apparatus not shown in the drawings similarly as Embodiment 1. Incidentally, all these processes are described as what comprise a single printing method. However, the present invention is not limited to this Embodiment. That is, all these processes can be included in an overall control program of the printer apparatus as a part of it, so as to perform an overall control process including printing process together with other control process. This is same as Embodiment 1.

<Effect of Embodiment 2>

As described above, according to Embodiment 2, the following effects are obtained, because sheet feeder jam relief is demand only after duplex printing has completed and the printed media issued in the occasion when conveying route for medium from the duplex printing unit is secured and medium completely printed with only one of its faces exists in the duplex printing unit. (1) There is no need of abandoning medium in the duplex printing unit, which one face has a complete printing.

(2) There is no need for operators to make the other face printed by themselves after relief of jam.

<Embodiment 3>

Embodiment 3 relates to a method of continuing printing by changing sheet feeder cassette; in the occasion when route for conveying medium from the sheet feeder cassette other than that is now feeding media is secured, and both size and position of media are same; at the moment when jam occurred. Here, the state that route for conveying media is secured, means the state that there is no hindrance in the route for conveying media such as jam in the sheet feeder.

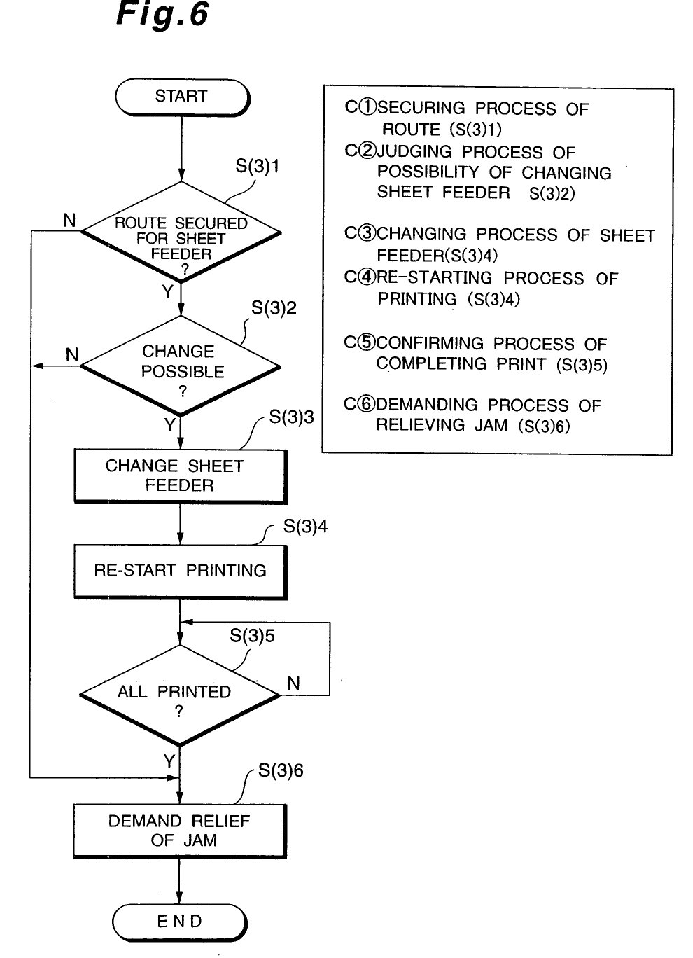

FIG. 6 is a flow-chart showing the printing process according to Embodiment 3.

As shown in FIG. 6, the printing method of Embodiment 3 comprises C\mathring{1} process of securing route for conveying media, C\mathring{2} process of judging propriety of changing sheet feeder cassette, C\mathring{3} process of changing sheet feeder cassette, C\mathring{4} process of re-starting printing process, C\mathring{5} process of confirming completion of printing, and C\mathring{6} process of demanding relief of jam in sheet feeder.

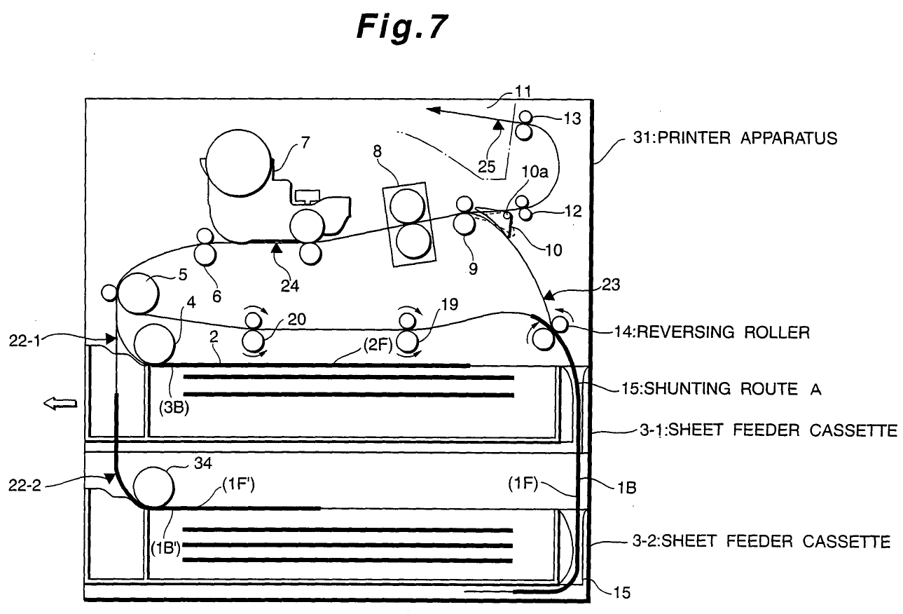

FIG. 7 shows the state of conveying medium according to Embodiment 3.

As shown in FIG. 7, the printer apparatus 31 used in Embodiment 3 has, for example, two sheets feeder cassette 3-1 and 3-2. The first medium (1F), 1B fed from the sheet feeder cassette 3-1 is inserted in the duplex printing unit 15. And, the second medium (2F),(2B) has caused sheet feed jam at the position of sheet feeding roller 4. Therefore, another first medium (1F),(1B′) will be fed from the sheet feeder cassette 3-2 instead of the sheet feeder cassette 3-1. This state is shown in FIG. 7. Hereafter, media fed from the sheet feeder cassette 3-2 are designated by letters attached primes such as the first media (1F′),(1B′).

C\mathring{1} Process of Securing Route for Conveying Media.

This is a process performed to judge whether there is a sheet feeder cassette connected with secured route for conveying media. This process corresponds to the step S(3)1 in flow-chart. As shown in FIG. 7, the printer apparatus 3 1 is attached with another sheet feeder cassette 8-2 different from the sheet feeder cassette 3-1 now feeding media for printing. It is provided that there is no hindrance in the route for conveying media from the sheet feeder cassette 3-2, because jam of medium from the sheet feeder cassette 3-1 occurred at the position where the sheet feeding roller 4 exists. In this occasion, the printing control judges that the route for conveying media is secure. And, it proceeds to the next step S(3)2. On the contrary, in the occasion when jam of medium occurred at the position of image forming section 7 etc, the control judges that the route for conveying media is not secure. And, it jumps to the step S(3)6 in flow-chart.

C\mathring{2} Process of Judging Propriety of Changing Sheet Feeder.

This is a process performed to judge whether the condition of medium that is size and position of media accord between the sheet feeder cassette 3-1 and the sheet feeder cassette 3-2. This process corresponds to the step S(3)2 in flow-chart. In this occasion, size and position of media in both cassette plus what is called media type, media unit etc. are compared. And, when it is judged that sheet feeder change is impossible, the control jumps to the step S(3)6 in flow-chart. On the other hand, when the change is possible, the control proceeds to the next step s(3)3. This judgement is performed according to data from each kind of sensor such as a sheet size sensor etc. not shown in the drawings.

C\mathring{3} Process of Changing Sheet Feeder

This is a process performed to change sheet feeder now feeding media from its cassette to sheet feeder which is able to feed new media. This process corresponds to the step S(3)3 in flow-chart. Here, the sending roller 4 connected with sheet feeder cassette 3-1has stopped. Instead, the sending roller 34 connected with sheet feeder cassette 3-2 starts rotating. Then, the control proceeds to the next step S(3)4.

C\mathring{4} Process of Re-Starting Printing

This is a process performed to re-start printing. This process corresponds to the step S(3)4 in flow-chart. Here, the sheet feeder cassette 3-2 feeds new media instead of the sheet feeder cassette 3-1 causing jam.

C\mathring{5} Process of Confirming Completion of Printing

This is a process performed to watch new media from sheet feeder cassette 3-2. This process corresponds to the step S(8)5 in flow-chart. Here, all the media fed from sheet feeder cassette 8-2 are watched continuously until they all complete printing and issue at outlet portion 11. These media are watched by a feeding sensor 22-2, the outlet sensor 25 etc. And, when it is judged that all the mediums completed printing, the control proceeds to the next step S(3)6.

C\mathring{6} Process of Ordering the Operator to Relieve Jam in Sheet Feeder.

This is a process performed to order the operator to relieve jam. This process corresponds to the step S(3)6 in flow-chart. And, this is the step performed when all the media fed from the sheet feeder cassette 3-2 completed printing and issued at the outlet portion 11. Before this step, all the printing processes completed. Then, relief of jam is demanded at this step.

The operation described above is performed by a control section of the printer apparatus 31 not shown in the drawings. Incidentally, in the description mentioned above, what is provided with two sheet feeder cassettes, is described. However, the present invention is not limited to this embodiment. That is, the number of sheet feeder cassettes can be more than two. In this occasion, it is enough if conveying route of either of the sheet feeder cassettes other than the one now operating is secure. Moreover, the operation of Embodiment 1 or 2 can be added to the operation of Embodiment 3.

Moreover, in the description mentioned above, the operation of Embodiment 3 is divided into processes. And, each of these processes are described as an independent method of an overall printing process. However, the present invention is not limited to this Embodiment. That is, as mentioned in Embodiment 1 and 2, all these processes can be included in an overall control program as a part of it. And, it can be executed step by step including steps corresponding to the processes of Embodiment 3 together with other steps of other kind of control.

<Effect of Embodiment 3>

As described above, according to Embodiment 3, instead of the sheet feeder cassette that caused jam, other sheet feeder cassette connected to secure conveying route and containing same kind of media, is used. Therefore, following effects are obtained.

(1) The printing process can be continued as far as media are contained in the selected sheet feeder cassette.

(2) Therefore, labor of the operator can be improved, because the operator is able to deal with relief of jam after a series of printing job now executing is completed.

What is claimed is:

1. A printing method of printer apparatus having mechanism for reversing media, so as to perform duplex printing; wherein, at the detection of occurrence of a sheet feeder jam, in the occasion when at least one medium in the course of one face printing exists, the one face printing with this medium is continued, and this medium is conveyed in said mechanism for reversing medium, after the one face printing completed; then relief of sheet feeder jam is demanded, and printing process is re-started after jam is relieved.

2. A printing method of printer apparatus according to claim 1; wherein
at the re-starting of said printing process, either said medium printed with one face or a new medium fed from the sheet feeder cassette of said printer apparatus, is selected.

3. A printing method of printer apparatus having a duplex printing unit for reversing media, and demanding relief of said sheet feeder jam at the occurrence of said sheet feeder jam; wherein
at the detection of occurrence of said sheet feeder jam, in the occasion when medium printed with one face exist in said duplex printing unit, printing process to the other face of medium is performed, and after the printing process is completed, a relief of sheet feeder jam is demanded.

4. A printing method of printer apparatus demanding relief of said sheet feeder jam at the occurrence of said sheet feeder jam; wherein conveying route for media in said printer apparatus is watched, a sheet feeder cassette able to be changed with the sheet feeder cassette causing said sheet feeder jam, is selected, and printing process is continued with media fed from the changed sheet feeder cassette; after all the media fed from every available sheet feeder cassette is exhausted, a relief of jam is demanded.

5. A printer apparatus for duplex printing, comprising:
a first conveying route for conveying fed media,
a shunting route for reversing media,
an image forming section for forming image on media conveyed from the first conveying route and the shunting route,
an outlet portion for issuing media,
an interchanging section for interchanging between the outlet portion and the shunting route to send media sent from the image forming section,
a shunting route sensor for detecting state of the shunting route,
sensors on the first conveying route for detecting state of the first conveying route, and
a controlling section for demanding relief of jam in the first conveying route after shunting media conveyed from the image forming section when an occurrence of media jam is detected on the first conveying route.

6. A printer apparatus for duplex printing, according to claim 5 wherein
the controlling section demands relief of jam in the first conveying route after shunting media conveyed from the image forming section and issuing the shunted media formed image on it by the image forming section when an occurrence of media jam is detected on the first conveying route.

7. A printer apparatus for duplex printing, according to claim 5 wherein
the controlling section performs control of conveying media in the shunting route and forming image by the image forming section after relieving jam when the shunting route sensor does not detect any change in the shunting route.

8. A printer apparatus for duplex printing, comprising:
a first conveying route for conveying fed media,
a second conveying route other than the first conveying route for conveying fed media,
an image forming section for forming image on media conveyed from the first conveying route or the second conveying route,
sensors on the first conveying route for detecting state of the first conveying route, and
a controlling section for changing route for conveying media from the first conveying route to the second conveying route when an occurrence of media jam is detected on the first conveying route.

9. A printer apparatus for duplex printing, according to claim 8 wherein
the first conveying route conveys media fed from a first sheet feeder cassette and
the second conveying route conveys media fed from a second sheet feeder cassette.
